(19) United States
(12) Patent Application Publication
(10) Pub. No.: US 2003/0058641 A1
(43) Pub. Date: Mar. 27, 2003

(54) Led indicator lamp

(76) Inventors: Kazunori Watanabe, Anan-shi (JP); Masaru Kato, Anan-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/257,035

(22) PCT Filed: Feb. 9, 2001
(86) PCT No.: PCT/JP01/00942

(51) Int. Cl. F21V 11/00

(52) U.S. Cl. 362/235; 362/308; 362/309; 362/800

(57) ABSTRACT

An LED indication lamp having desired luminous intensity distribution characteristics without need for any light-emitting diode of special shape. The LED indication lamp comprising a plurality of light-emitting diodes and having specified luminous intensity distribution characteristics is further provided with a condenser lens. The light-emitting diodes are arranged in a pattern corresponding to a luminous intensity distribution pattern determined according to the luminous intensity distribution characteristics. The light-emitting diodes thus arranged and the condenser lens are arranged so that the light emitted from the light-emitting diodes in the luminous intensity distribution pattern through the condenser lens satisfies the luminous intensity distribution characteristics.

### BACKGROUND OF THE INVENTION

1. Field of the Invention

The present invention relates to an LED indicator lamp, particularly to an LED indicator lamp used in traffic signals.

2. Description of the Related Art

As light emitting diodes capable of emitting light of R, G and B primary colors and light emitting diodes capable of emitting white light with high luminance have been developed, LED indicator lamps constituted from a plurality of light emitting diodes arranged in an array have been put in use for various applications. The LED indicator lamp has a far higher service life than that of an incandescent lamp, and also shows a high efficiency and a high resistance against vibration. For these advantages, the LED indicator lamp has been used in advertising sign boards, traffic sign boards displaying route guide or traffic information, light source for traffic signals and large screens.

With regards to the application to traffic signals, in particular, while the incandescent lamp used as the light source of the conventional traffic signal requires large reflector mirrors and color filters, the LED indicator lamp has such advantages as the capability to emit light of a single color that eliminates the need for a color filter and the capability to emit light with some degree of directivity that eliminates the need to install a large reflector mirror.

Moreover, a traffic signal constituted from LEDs that does not need reflector mirrors and color filters also has an advantage of being free from spurious lighting that is caused by extraneous light that has entered the traffic light and reflected on the reflector mirror placed behind an incandescent lamp comes out of the traffic signal through a color filter.

A constitution of a traffic signal using light emitting diodes is disclosed in U.S. Pat. No. 6,019,493 wherein a high efficiency light emitting element capable of uniform light emission is constituted by providing a lens made by integrally forming a central convex lens and a plurality of annular convex lenses located around the central convex lens.

International Patent Application PCT/IB97/01974 (International Publication No. WO98/16777) discloses an LED indicator lamp that has a convex lens (Fresnel lens) placed in front thereof and a plurality of light emitting diodes distributed densely around the optical axis so that failure of one of the light emitting diodes does not cause significant change in the light intensity distribution.

The LED indicator lamp used in traffic signals and sign boards is usually installed at overhead height so as to be recognized by many people from a distance. As such, the LED indicator lamp is required to emit light with horizontally symmetrical intensity distribution but asymmetrical intensity distribution in vertical direction so that light intensity is higher in the front field and the lower field.

As it has been made possible to increase the luminous intensity of light emitting diodes recently, it is enabled to decrease the number of light emitting diodes required in an LED indicator lamp.

However, a new problem has arisen that it is difficult to achieve planar light emission of uniform intensity with an LED indicator lamp consisting of a small number of light emitting diodes that have high luminous intensity.

### SUMMARY OF THE INVENTION

An object of the present invention is to provide an LED indicator lamp that is capable of achieving planar light emission of uniform intensity and a desired luminous intensity distribution characteristic.

In order to achieve the object described above, a first LED indicator lamp of the present invention has a predetermined luminous intensity distribution characteristic comprising a plurality of light emitting diodes and a condenser lens, wherein the plurality of light emitting diodes are arranged in a pattern that corresponds to a luminous intensity distribution pattern that is set according to the luminous intensity distribution characteristic described above, while the light emitting diodes and the condenser lens are arranged so that the luminous intensity distribution characteristic is achieved by the light that is emitted by the plurality of light emitting diodes and output through the condenser lens in the luminous intensity distribution pattern.

The first LED indicator lamp of the present invention that is constituted as described above can achieve planar light emission of uniform intensity, since the light emitted by the plurality of light emitting diodes is viewed through the condenser lens.

With the constitution described above, a desired luminous intensity distribution pattern can be easily formed since the luminous intensity distribution pattern is determined by the combination of the arrangement pattern of the plurality of light emitting diodes and the relative positions of the light emitting diodes and the condenser lens.

In this specification, the term luminous intensity distribution characteristic is used in a broader sense than luminous intensity distribution pattern and includes luminous intensity distribution pattern.

The luminous intensity distribution pattern determined according to luminous intensity distribution characteristic means, for example, a luminous intensity distribution pattern that is suitable for achieving the luminous intensity distribution characteristic and, in case the luminous intensity distribution characteristic is represented by a particular luminous intensity distribution pattern, means the luminous intensity distribution pattern itself.

Moreover, an arrangement pattern that corresponds to a luminous intensity distribution pattern means an arrangement pattern that, in combination with one or more other element, can achieve the luminous intensity distribution pattern.

In the first LED indicator lamp of the present invention, the plurality of light emitting diodes are preferably located at the focus of the condenser lens or in the vicinity thereof.

Also in the first LED indicator lamp of the present invention, the plurality of light emitting diodes may be arranged on a plane that crosses the optical axis at right angles at the focus of the condenser lens or in the vicinity thereof.

Also in the first LED indicator lamp of the present invention, the plurality of light emitting diodes may be arranged on a plane that crosses the optical axis obliquely at the focus of the condenser lens or in the vicinity thereof.

Such a constitution as described above makes it possible to change the luminous intensity distribution pattern in accordance to the angle between the plane and the optical axis.

Also in the first LED indicator lamp of the present invention, the plurality of light emitting diodes may be distributed in a three-dimensional arrangement at the focus of the condenser lens or in the vicinity thereof.

This constitution makes it possible to form the luminous intensity distribution pattern in accordance to the three-dimensional arrangement of the light emitting diodes.

In the first LED indicator lamp of the present invention, the condenser lens is preferably a Fresnel lens that can be made thin and light in weight.

Also in the first LED indicator lamp of the present invention, the plurality of light emitting diodes may be disposed in such an arrangement as the number of light emitting diodes located above the optical axis is larger than the number of light emitting diodes located below the optical axis, which enables it to direct light with higher intensity downward than upward.

In this specification, the words up and down refer to the upper and lower positions in a setup where the LED indicator lamp is used.

Also in the first LED indicator lamp of the present invention, the plurality of light emitting diodes may be disposed in such an arrangement as the light emitting diodes are distributed in one portion with a density different from that in other portions.

This constitution makes it possible to change the light intensity depending on the direction through varying density of the light emitting diodes.

Furthermore, in the first LED indicator lamp of the present invention, the plurality of light emitting diodes may include light emitting diodes that are intended to correct unevenness in the light intensity distribution of the luminous intensity distribution pattern produced by the light emitted through the condenser lens.

Also in the first LED indicator lamp of the present invention, the plurality of light emitting diodes may be disposed in such an arrangement as the light emitting diodes are placed in at least one portion at intervals different from the intervals between light emitting diodes in other portion.

This constitution makes it possible to change the light intensity distribution in the luminous intensity distribution pattern through varying intervals between the light emitting diodes.

The first LED indicator lamp of the present invention may also have a translucent cover placed in front of the condenser lens.

The translucent cover preferably has a lens pattern formed thereon so as to smooth out the periodic intensity distribution generated by the periodic arrangement of the light emitting diodes.

A second LED indicator lamp of the present invention has a predetermined luminous intensity distribution characteristic comprising a plurality of light emitting diodes, a condenser lens placed in front of the plurality of light emitting diodes and a translucent cover with a lens pattern formed thereon being placed in front of the condenser lens, wherein the plurality of light emitting diodes are arranged in a pattern that corresponds to a luminous intensity distribution pattern that is set according to the luminous intensity distribution characteristic described above, while the light emitting diodes, the condenser lens and the translucent cover are arranged so that the luminous intensity distribution characteristic is achieved by the light that is emitted by the plurality of light emitting diodes through the condenser lens and the translucent cover in the luminous intensity distribution pattern.

The second LED indicator lamp of the present invention that is constituted as described above can achieve the luminous intensity distribution characteristic by means of the translucent cover in addition to the light emitting diodes and the condenser lens, and therefore makes it possible to form a luminous intensity distribution pattern that is difficult to form with only the light emitting diodes and the condenser lens, thereby satisfying broader requirements.

In the second LED indicator lamp of the present invention, the lens pattern formed on the translucent cover preferably formed so as to smooth out the periodic intensity distribution generated by the periodic arrangement of the light emitting diodes and make the luminance uniform over the light emitting plane.

### BRIEF DESCRIPTION OF THE DRAWINGS

FIG. 1 is an exploded perspective view showing the constitution of LED indicator lamp according to an embodiment of the present invention.

FIG. 2 is a plan view schematically showing the arrangement of light emitting diodes in the LED indicator lamp of the embodiment.

FIG. 3A is a plan view showing the inner surface of a lens pattern of a translucent cover according to the embodiment.

FIG. 3B is a perspective view showing the inner surface of a lens pattern of a translucent cover according to the embodiment.

FIG. 4 through FIG. 8 schematically show luminous intensity distribution patterns corresponding to the arrangement of the light emitting diodes.

FIG. 9 is a graph showing an example of luminous intensity distribution characteristic according to the embodiment.

FIG. 10 is a plan view showing the arrangement of light emitting diodes in the LED indicator lamp of a variation of the present invention.

FIG. 11A is a plan view showing the arrangement of light emitting diodes in a variation of the present invention different from that of FIG. 10.

FIG. 11B is a graph schematically showing the intensity distribution as a function of angle in the case of arranging the light emitting diodes as shown in FIG. 11A.

FIG. 12A is a diagram schematically showing an image formed on an imaginary screen when two light emitting diodes are placed on a plane perpendicular to the optical axis of the condenser lens 3.

FIG. 12B is a schematic diagram showing a constitution when two light emitting diodes are placed on a plane perpendicular to the optical axis of the condenser lens 3.

FIG. 13A is a diagram schematically showing an image formed on an imaginary screen when two light emitting diodes are placed on a plane that is inclined against the optical axis of the condenser lens 3.

FIG. 13B is a schematic diagram showing the constitution when two light emitting diodes are placed on a plane that is inclined against the optical axis of the condenser lens 3.

FIG. 14A is a diagram schematically showing an image formed on an imaginary screen when a plurality of light emitting diodes are disposed in three-dimensional arrangement shown in FIG. 14B.

FIG. 14B is a schematic diagram showing an example of in three-dimensional arrangement of a plurality of light emitting diodes.

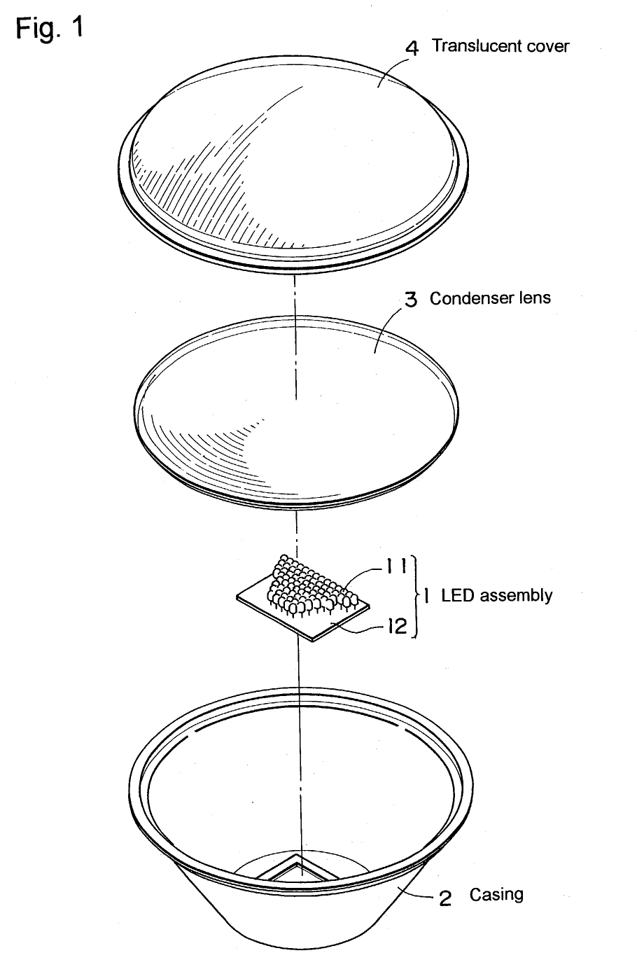

### DESCRIPTION OF THE PREFERRED EMBODIMENTS

Now the LED indicator lamp according to an embodiment of the present invention will be described below.

The LED indicator lamp of the present invention is an LED indicator lamp comprising a casing 2 of truncated conical shape that has a round bottom surface and an opening having larger diameter than that of the bottom surface, an LED assembly 1 having a plurality of light emitting diodes 11, 11a disposed on a substrate 12 placed at the bottom of the casing 2, a condenser lens 2 located at the opening of the casing 2 and a translucent cover 4 located at the opening of the casing 2 so as to cover the condenser lens 3, so that light is emitted in a predetermined luminous intensity distribution pattern.

In more detail, the condenser lens 3 of the LED indicator lamp of the present invention is a Fresnel lens that has the function of a convex lens where light incident on one plane thereof exits from the plane on the other side and is focused, and is placed at the opening of the casing 2 so that center of the lens substantially corresponds with the opening of the casing 2.

The LED assembly 1 of this embodiment is made by placing the plurality of light emitting diodes 11, 11a on the substrate 12 in such an arrangement as described below.

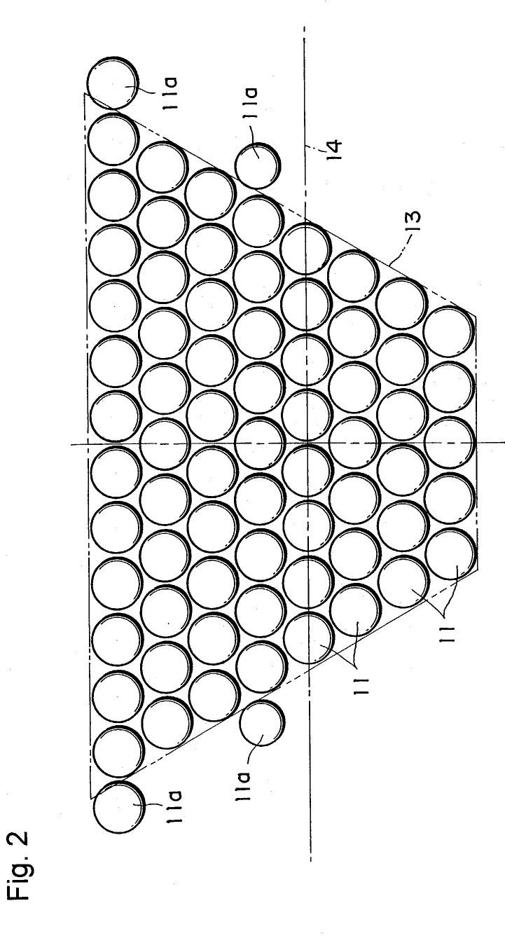

In the LED assembly 1, the plurality of light emitting diodes 11 are disposed on the substrate 12 so as to constitute a fundamental arrangement pattern 13 corresponding to a luminous intensity distribution pattern that satisfies a luminous intensity distribution characteristic required of the LED indicator lamp, as shown in FIG. 2.

The light emitting diode 11a is provided to correct the luminous intensity distribution pattern or the light intensity distribution generated by the fundamental arrangement pattern 13 so as to form a luminous intensity distribution pattern generated through the condenser lens 3 approximate to the desired luminous intensity distribution pattern or to smooth out the unevenness in the intensity distribution, and is placed at a predetermined position in the vicinity of the fundamental arrangement pattern 13.

In the LED assembly 1 of this embodiment, the fundamental arrangement pattern 13 is formed so as to comply with a rule that corresponds to the desired luminous intensity distribution pattern.

More specifically, the fundamental arrangement pattern 13 of this embodiment is such that the light emitting diodes are disposed along a plurality of horizontal lines parallel to reference horizontal lines that are perpendicular to the optical axis of the condenser lens 3, while the number of light emitting diodes disposed on one horizontal line is made larger on the horizontal line located higher.

FIG. 2 shows that the number of light emitting diodes disposed on one horizontal line is one more than the number of light emitting diodes disposed on the horizontal line located just below. However, the present invention is not limited to this constitution, and any arrangement of the light emitting diodes 11 may be employed as long as a luminous intensity distribution pattern that satisfies the luminous intensity distribution characteristic required of the LED indicator lamp can be achieved.

Also according to the present invention, the light emitting diodes may be arranged according to such a simple rule as, for example, the number of light emitting diodes disposed on a horizontal line located above the optical axis is larger than the largest of the numbers of light emitting diodes disposed on horizontal lines located below the optical axis, as long as the luminous intensity distribution characteristic required of the LED indicator lamp can be achieved.

The LED assembly 1 having the constitution described above is placed at the bottom of the casing 2 so that a particular point (datum point) of the fundamental arrangement pattern is located on the axis of the casing 2 that has a truncated conical shape, namely the optical axis of the condenser lens 3. With this configuration, the luminous intensity distribution pattern that satisfies the luminous intensity distribution characteristic required of the LED indicator lamp and the luminous intensity distribution pattern formed by the arrangement of the light emitting diodes and the condenser lens 3 can be made substantially identical with each other.

When the arrangement pattern of the light emitting diodes is moved in the direction perpendicular to the optical axis of the condenser lens 3, the luminous intensity distribution pattern generated by the light emitted through the condenser lens 3 changes as the position of the light emitting diodes changes. Therefore it is necessary to align the condenser lens 3 and the LED assembly 1 so that the luminous intensity distribution pattern formed by the arrangement of the light emitting diodes and the condenser lens 3 agrees with the luminous intensity distribution pattern that satisfies the luminous intensity distribution characteristic required of the LED indicator lamp.

The luminous intensity distribution pattern formed by the arrangement of the light emitting diodes and the condenser lens 3 can be made agree with the desired luminous intensity distribution pattern, by moving the arrangement pattern of the light emitting diodes in the direction perpendicular to the optical axis of the condenser lens 3, regardless of where the LED assembly 1 is located, either at the focus of the condenser lens 3, in the vicinity of the focus, before the focus or behind the focus.

That is, the LED indicator lamp of this embodiment achieves the desired luminous intensity distribution pattern by setting the arrangement pattern of the light emitting diodes in the LED assembly 1 in correspondence to the luminous intensity distribution pattern that satisfies the luminous intensity distribution characteristic required of the LED indicator lamp, and setting the relative positions of the condenser lens 3 and the LED assembly 1 (determining the distance between of the condenser lens 3 and the LED assembly 1 and the position of the LED assembly 1 in the plane perpendicular to the optical axis of the condenser lens 3) so that the luminous intensity distribution pattern formed by the arrangement of the light emitting diodes and the condenser lens 3 agrees with the luminous intensity distribution pattern that satisfies the luminous intensity distribution characteristic required of the LED indicator lamp.

Since the distance between of the condenser lens 3 and the LED assembly 1 is determined depending on the position of the LED assembly 1 (arrangement pattern of the light emitting diodes) relative to the optical axis of the condenser lens 3. Location of the LED assembly 1 is not limited to a particular position. However, it is preferable to locate the LED assembly 1 at the focus of the condenser lens 3, in the vicinity of the focus, or behind the focus for the reason described below.

In the LED indicator lamp of this embodiment, the translucent cover 4 is provided in order to eliminate the unevenness in the light intensity that varies with small period in space in the luminous intensity distribution pattern generated by the light emitted through the condenser lens 3. The unevenness in the light intensity that varies with small period in space refers to the variations in the light intensity with small period caused by the periodic arrangement of the light emitting diodes. This variation causes the individual light emitting diodes to be recognized as dots when the light emitted through the condenser lens 3 is directly observed, thus resulting in deterioration in perception.

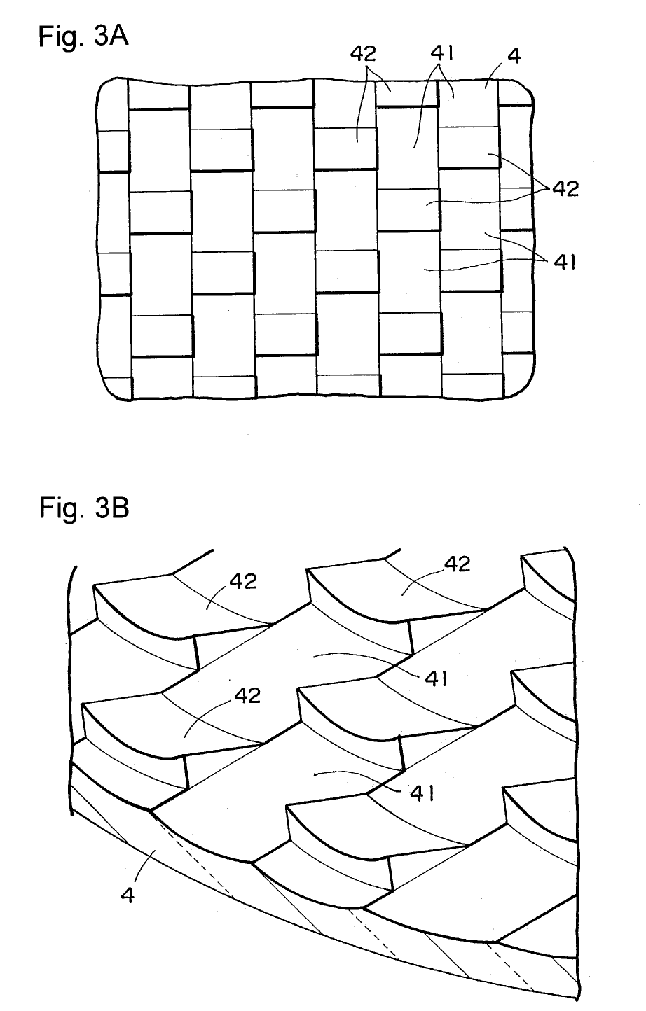

In the LED indicator lamp of this embodiment, the translucent cover 4 has such a lens pattern as a plurality of lenses 41, 42 shown in FIG. 3 are periodically arranged on the inner surface of the translucent cover 4, in order to eliminate the unevenness in the light intensity that varies with small period in space in the luminous intensity distribution pattern of the light emitted through the condenser lens 3.

More specifically, each lens 41 has a concave surface 41 constituted from a part of inner surface of a cylinder so that the incident light is diffused in the horizontal plane, while the concave surface 42 is formed to incline from the vertical direction, so as to deflect the incident light downward.

Variation in light intensity with small period is eliminated by alternately arranging the lenses 41, 42 of different characteristics.

(Principle of Forming the Luminous Intensity Distribution Pattern in the Embodiment)

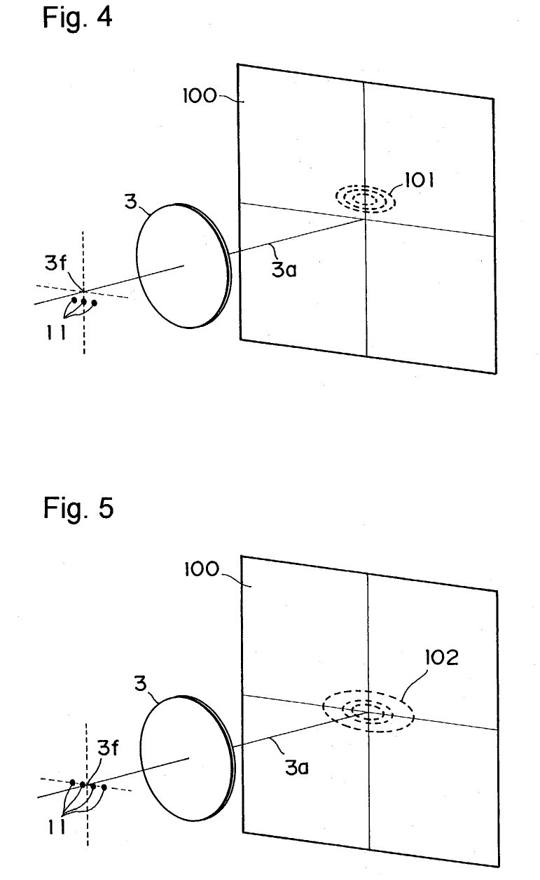

Now the principle of forming the luminous intensity distribution pattern in this embodiment will be described in more detail below with reference to FIG. 4 through FIG. 8.

FIG. 4 through FIG. 8 are perspective views schematically showing the luminous intensity distribution pattern corresponding to the arrangement pattern of the light emitting diodes. A plurality of the light emitting diodes 11 are disposed in the horizontal direction on a plane (hereinafter referred to as emission plane) that includes a focal point 3f located behind the condenser lens 3 and is perpendicular to the optical axis 3a.

FIG. 4 schematically shows a luminous intensity distribution pattern formed by light rays emitted by three light emitting diodes that are arranged on a horizontal line located below the focal point 3f of the condenser lens 3 in the emission plane, illustrated by way of an image 101 formed on an imaginary image plane 100 located in front of the condenser lens 3.

As shown in FIG. 4, the image 101, formed by the light emitted by the light emitting diodes that are located below the focal point 3f of the condenser lens 3 in the emission plane, is located above the optical axis 3a in the image plane 100. When the three light emitting diodes are moved downward in the emission plane, the image 101 moves upward in the image plane 100.

FIG. 5 schematically shows a luminous intensity distribution pattern formed by light rays emitted by four light emitting diodes that are arranged on a horizontal line including the focal point 3f of the condenser lens 3 in the emission plane, illustrated by way of an image 102 formed on the image plane 100.

As shown in FIG. 5, the image 102, formed by the light emitted by the light emitting diodes that are located on the horizontal line that includes the focal point 3f in the emission plane, is observed as an image spreading vertically and horizontally around the intersect of the image plane 100 and the optical axis 3a in the image plane 100.

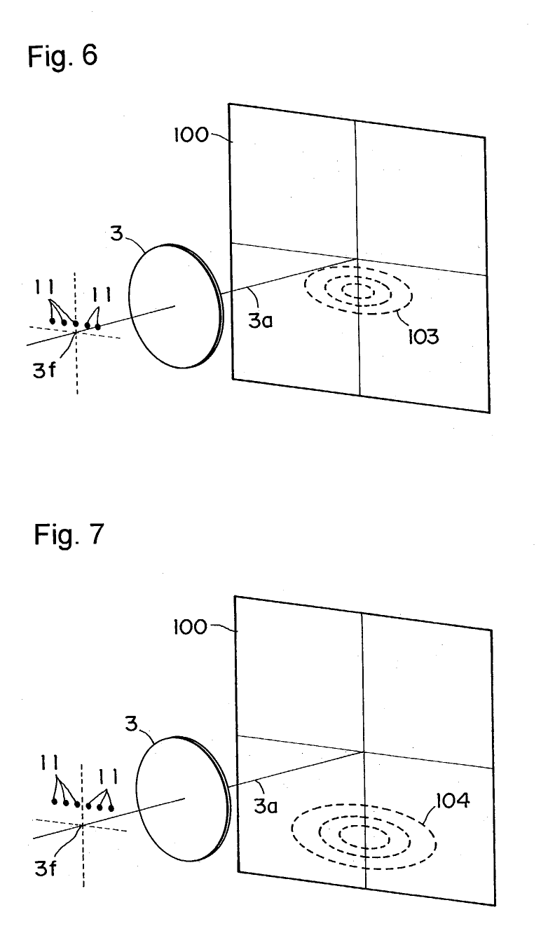

FIG. 6 schematically shows a luminous intensity distribution pattern formed by light rays emitted by five light emitting diodes that are arranged on a horizontal line located above the focal point 3f in the emission plane, illustrated by way of an image 103 formed on the imaginary image plane 100 located in front of the condenser lens 3.

As shown in FIG. 6, the image 103, formed by the light emitted by the light emitting diodes that are located above the focal point 3f of the condenser lens 3 in the emission plane, is located below the optical axis 3a in the image plane 100. When the five light emitting diodes are moved upward in the emission plane, the image 103 moves downward in the image plane 100.

FIG. 7 schematically shows a luminous intensity distribution pattern formed by light rays emitted by six light emitting diodes that are arranged on a horizontal line located above the focal point 3f higher than in the case of FIG. 6 in the emission plane, illustrated by way of an image 104 formed on the imaginary image plane 100.

As shown in FIG. 7, when the light emitting diodes are placed higher than in the case of FIG. 6 in the emission plane, the image 104 is formed further lower than in the case of FIG. 6 in the image plane 100.

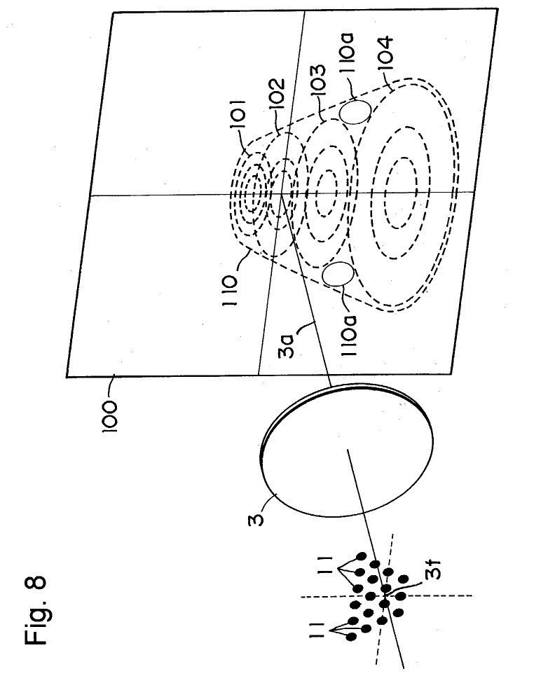

FIG. 8 shows an image 110 formed on the image plane 100 when the light emitting diodes of the arrangements shown in FIG. 4 through FIG. 7 are all arranged in the emission plane.

In this case, the image 110 is formed by overlapping of images 101, 102, 103 and 104 formed by the light emitting diodes arranged along each horizontal line as schematically in FIG. 8.

As shown in FIG. 8, when the light emitting diodes are disposed in such an arrangement as the number of light emitting diodes disposed along a horizontal line that is located above is larger than the number of light emitting diodes 11 disposed along a horizontal line that is located below in the emission plane, and the light rays emitted by the plurality of light emitting diodes arranged as described above are output through the condenser lens 3, light spreads in the horizontal direction more widely in the upper field than the spread of light in the horizontal direction in the lower field.

When the arrangement pattern of the light emitting diodes 11 shown in FIG. 8 is moved upward as a whole, the image 110 moves downward in the image plane 100. When the arrangement pattern is moved downward as a whole, the image 110 moves upward in the image plane 100.

In other words, light can be deflected downward by moving the arrangement pattern upward in the emission plane, and light can be deflected upward by moving the arrangement pattern downward in the emission plane.

Similarly, light can be deflected to the left by moving the arrangement pattern to the right in the emission plane, and light can be deflected to the right by moving the arrangement pattern to the left in the emission plane.

Thus since the luminous intensity distribution characteristic is achieved by overlapping of the luminous intensity distribution characteristics of the light emitting diodes arranged in the individual lines, the overall luminous intensity distribution characteristic may include a portion of lower light intensity around the luminous intensity distribution pattern indicated with numeral 110a in FIG. 8.

In such a case, the unevenness in the light intensity can be smoothed by placing an additional light emitting diode at a position in the emission plane corresponding to the portion 110a. The light emitting diode 11a shown in FIG. 2 is provided for the purpose of achieving a luminous intensity distribution pattern similar to the desired luminous intensity distribution pattern by smoothing the unevenness in the light intensity.

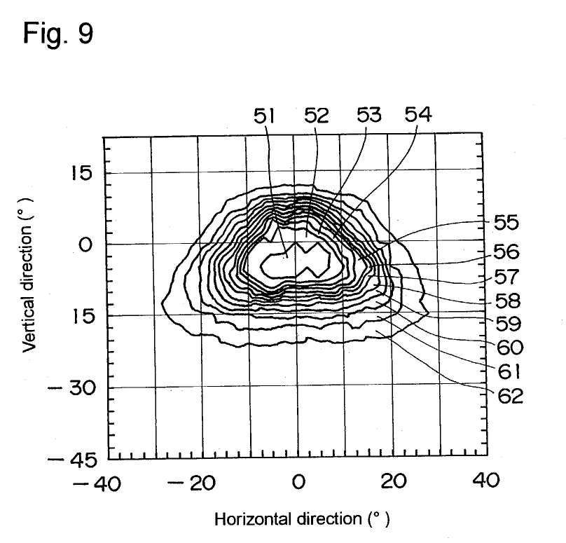

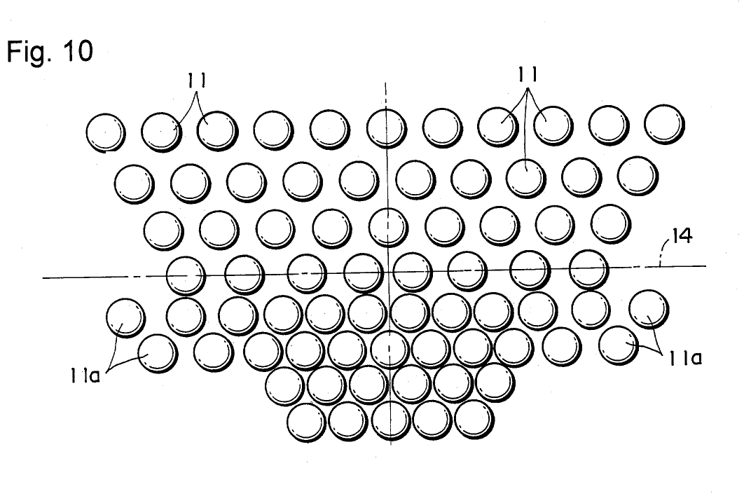

FIG. 9 is a graph of light intensity distribution in an image plane for an example of luminous intensity distribution characteristic in case the light emitting diodes are arranged as shown in FIG. 2.

Data shown in FIG. 9 were obtained by measurement using a condenser lens 300 nm in diameter having focal length of 120 mm and light emitting diodes arranged in a plane that includes the focal point of the condenser lens 3 and is perpendicular to the optical axis.

Luminous intensities in the regions shown in FIG. 9 are as follows:

Region enclosed by line 51: 600 candelas or higher

Region enclosed by line 51 and line 52; from 550 to 600 candelas

Region enclosed by line 52 and line 53; from 500 to 550 candelas

Region enclosed by line 53 and line 54; from 450 to 500 candelas

Region enclosed by line 54 and line 55; from 400 to 450 candelas

Region enclosed by line 55 and line 56; from 350 to 400 candelas

Region enclosed by line 56 and line 57; from 300 to 350 candelas

Region enclosed by line 57 and line 58; from 250 to 300 candelas

Region enclosed by line 58 and line 59; from 200 to 250 candelas

Region enclosed by line 59 and line 60; from 150 to 200 candelas

Region enclosed by line 60 and line 61; from 100 to 150 candelas

Region enclosed by line 61 and line 62; from 50 to 100 candelas.

When it is desired to make the light intensity higher in a particular direction, density of the light emitting diodes in the portion of the arrangement pattern corresponding to the direction may be increased as will be described in a variation of the embodiment.

As described above, the LED indicator lamp according to the embodiment of the present invention can achieve the desired luminous intensity distribution pattern with a simple constitution, by employing the condenser lens 3 and arranging the light emitting diodes in the arrangement pattern that corresponds to the desired luminous intensity distribution pattern.

Also the LED indicator lamp according to the embodiment of the present invention allows it to change the direction of light emission (direction in which the light intensity is highest) while maintaining the basic luminous intensity distribution pattern, by changing the relative positions of the substrate whereon the plurality of light emitting diodes are arranged in the predetermined arrangement pattern and the condenser lens 3.

Variation

An LED indicator lamp of a variation of the present invention is constituted similarly to the LED indicator lamp of the embodiment except for changing the arrangement pattern of the light emitting diodes 11, 11a on the substrate 12.

In the LED indicator lamp of this variation, density of the light emitting diodes 11 disposed below a horizontal 14 that crosses the optical axis at right angles is made higher than the density of the light emitting diodes 11 disposed below the horizontal 14.

This constitution makes it possible to increase the light intensity in a particular portion that corresponds to the portion of high density in the arrangement pattern, thereby to achieve the desired intensity distribution in the luminous intensity distribution pattern in correspondence to the density of the arrangement pattern.

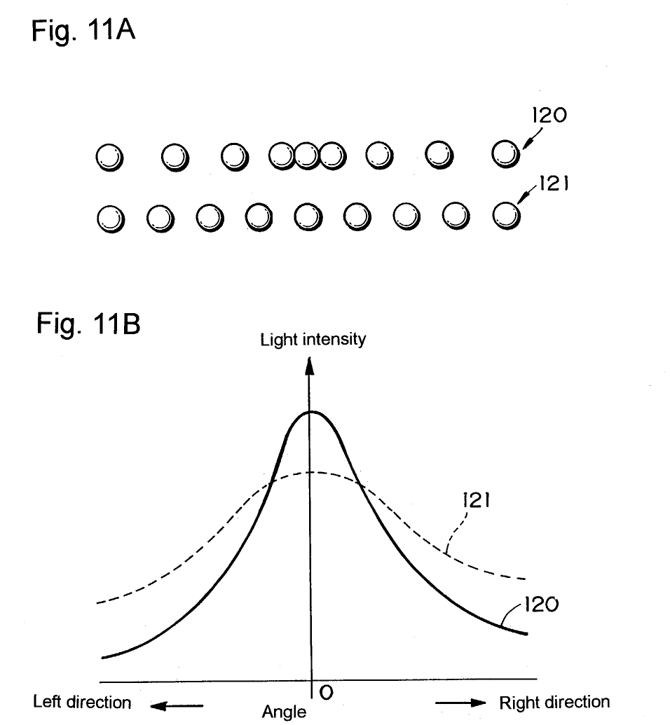

Also according to the present invention, spaces between adjacent light emitting diodes can be changed for the light emitting diodes disposed in the horizontal direction as shown in FIG. 11.

This makes it possible to change the light intensity distribution from the right to the left of the center in correspondence to the space between adjacent light emitting diodes.

FIG. 11B is a graph showing the situation described above. In FIG. 11B, light intensity distribution from the right to the left of the center is indicated schematically by solid line 120 when the space between the light emitting diodes located away from the center is made larger than the space between the light emitting diodes located near the center as shown in FIG. 11A.

In FIG. 11B, light intensity distribution from the right to the left is indicated schematically by dashed line 121 when the light emitting diodes are disposed with uniform density on the horizontal line for the purpose of comparison.

As will be clear from FIG. 11B, it is made possible to change the light intensity distribution from the right to the left of the center in correspondence to the space between adjacent light emitting diodes.

In the example shown in FIG. 11A, spaces between adjacent light emitting diodes disposed in the horizontal direction are changed. However, the present invention is not limited to this constitution and spaces between adjacent light emitting diodes disposed in the vertical direction may also be changed.

This makes it possible to change the light intensity distribution in the vertical direction around the center in correspondence to the space between adjacent light emitting diodes.

As will be made clear from the above description of the embodiment and the variation, the LED indicator lamp of the present invention achieves the desired luminous intensity distribution pattern by employing the condenser lens 3, the arrangement pattern of the plurality of light emitting diodes and the relative positions of the arrangement pattern and the condenser lens 3. Therefore, desired luminous intensity distribution patterns can be easily achieved to meet various requirements, by changing the density of the light emitting diodes in the arrangement pattern depending on the position, changing the space between adjacent light emitting diodes in the horizontal direction or the space between adjacent light emitting diodes in the vertical direction, in accordance to the desired luminous intensity distribution pattern to be achieved with the LED indicator lamp.

In the embodiment and the variation, the desired luminous intensity distribution pattern is achieved by means of the arrangement of the plurality of light emitting diodes and the condenser lens 3. However, the present invention is not limited to this constitution and the desired luminous intensity distribution pattern may also be formed by providing a lens pattern formed on the translucent cover 4 in addition to the plurality of light emitting diodes and the condenser lens 3.

Also in the embodiment and the variation, the arrangement pattern is constituted by arranging the plurality of light emitting diodes along horizontal lines in a plane perpendicular to the optical axis of the condenser lens 3, but the present invention is not limited to this constitution.

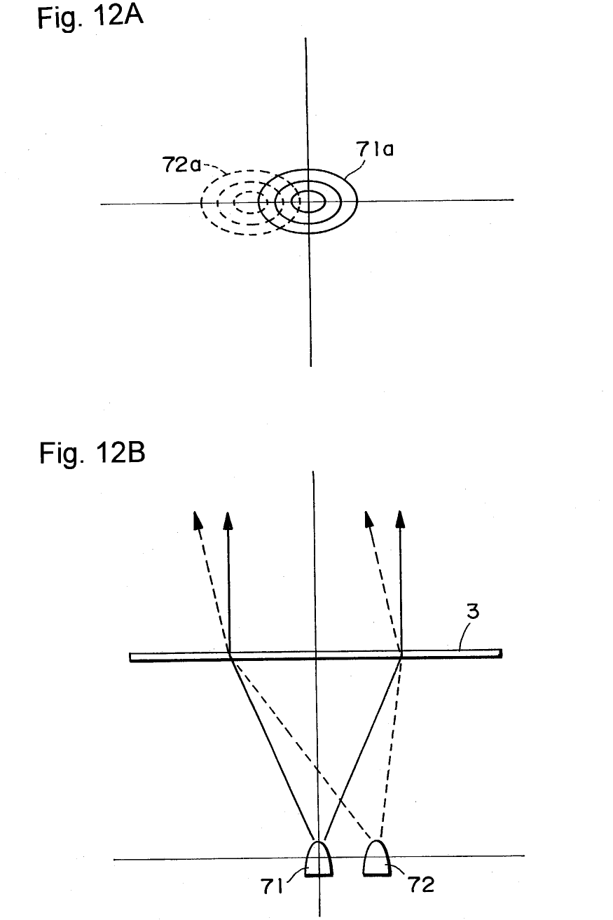

Specifically, when light emitting diodes 71, 72 are arranged in a plane perpendicular to the optical axis of the condenser lens 3 (FIG. 12B), images 71a, 72a are formed on a screen in correspondence to the light emitting diodes 71, 72 (FIG. 12A).

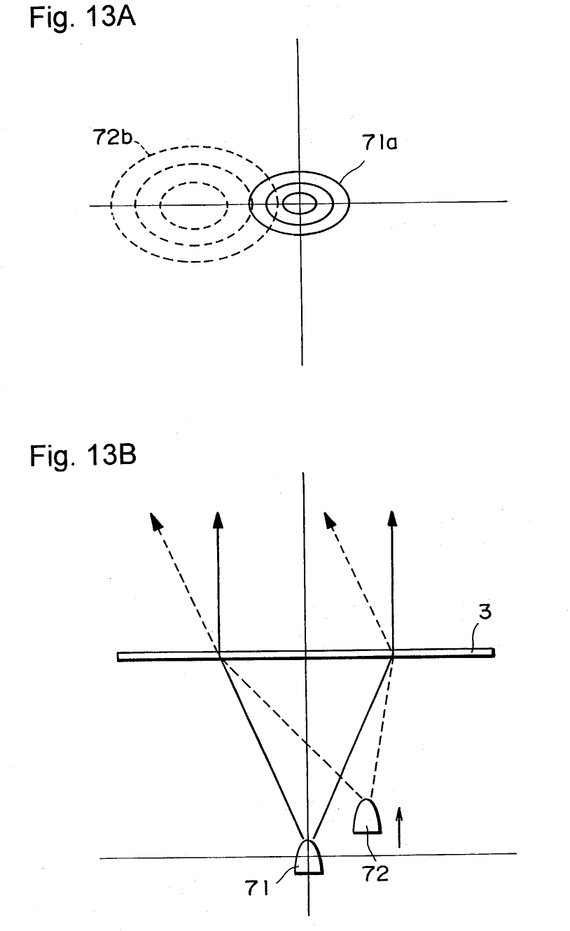

In case the light emitting diode 72 is located before the plane perpendicular to the optical axis of the condenser lens 3 (the plane where the light emitting diode 71 is placed) as shown in FIG. 13B, in contrast, image 72b of the light emitting diode 72 on the screen is spread to be larger than the image 72a shown in FIG. 12A, as shown in FIG. 13A.

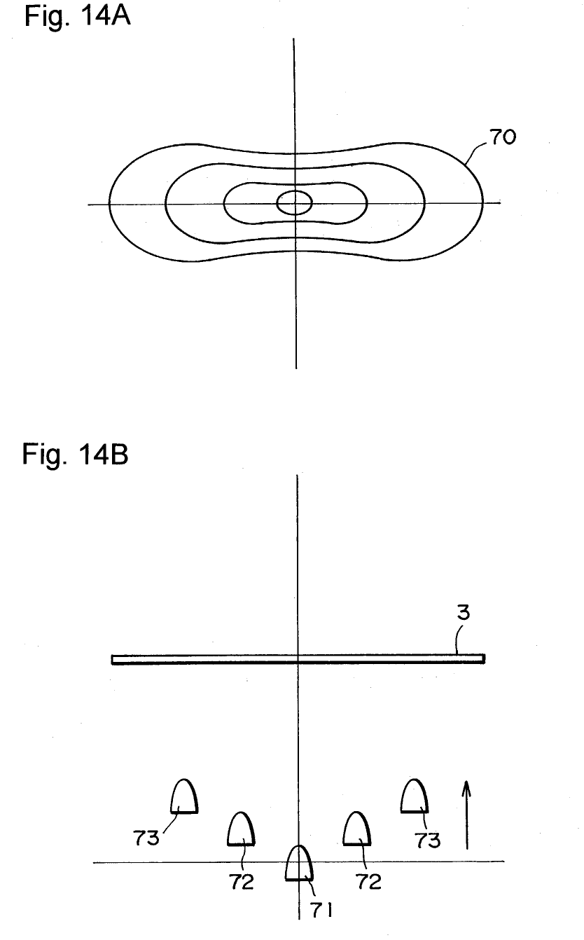

Therefore, a luminous intensity distribution pattern that is spread in the horizontal direction can be formed as indicated by the image 70 in FIG. 14A, by placing the light emitting diode 71 at the focal point of the condenser lens 3 and arranging the light emitting diodes 72, 73 at advanced positions according to the distance from the light emitting diode 71 to the left and right (FIG. 14B).

Thus according to the present invention, a luminous intensity distribution pattern that corresponds to the inclination of the plane where the light emitting diodes are arranged or to the three-dimensional arrangement of the light emitting diodes can be achieved, by inclining the plane where the plurality of light emitting diodes are arranged (so that the plane does not perpendicularly cross the optical axis of the condenser lens 3) or arranging the plurality of light emitting diodes in three-dimensional arrangement.

Three-dimensional arrangement of the light emitting diodes may be such as the light emitting diodes are disposed on the inner surface of a sphere, the light emitting diodes are disposed on the external surface of a sphere, or the light emitting diodes are disposed on two or more planes that cross each other.

As described in detail above, the present invention is capable of satisfying requirements for wide varieties of luminous intensity distribution characteristics by setting all or part of the components in accordance to the desired luminous intensity distribution pattern.

The LED indicator lamp of the present invention is capable of achieving the desired luminous intensity distribution pattern in order to meet wide varieties of requirements, and can therefore be applied to indicating lamps for various applications such as traffic lamp.

1. A LED indicator lamp which has a luminous intensity distribution characteristic comprising;
a plurality of light emitting diodes and a condenser lens,
wherein said plurality of light emitting diodes are arranged in a pattern that corresponds to a luminous intensity distribution pattern that is set based on said luminous intensity distribution characteristic,
while said light emitting diodes and said condenser lens are arranged so that the luminous intensity distribution characteristic is achieved by the light that is emitted by the plurality of light emitting diodes and output through the condenser lens in the luminous intensity distribution pattern.

2. The LED indicator lamp according to claim 1;
wherein said plurality of light emitting diodes are located at the focus of said condenser lens or in the vicinity thereof.

3. The LED indicator lamp according to claim 1;
wherein said plurality of light emitting diodes are arranged on a plane that crosses the optical axis at right angles at the focus of said condenser lens or in the vicinity thereof.

4. The LED indicator lamp according to claim 1;
wherein said plurality of light emitting diodes are arranged on a plane that crosses the optical axis obliquely at the focus of said condenser lens or in the vicinity thereof.

5. The LED indicator lamp according to claim 1;
wherein said plurality of light emitting diodes are distributed in a three-dimensional arrangement at the focus of said condenser lens or in the vicinity thereof.

6. The LED indicator lamp as in one of claims 1 to 5;
wherein said condenser lens is a Fresnel lense.

7. The LED indicator lamp as in one of claims 1 to 6;
wherein said plurality of light emitting diodes are disposed in such an arrangement as the number of light emitting diodes located above the optical axis is larger than the number of light emitting diodes located below the optical axis.

8. The LED indicator lamp as in one of claims 1 to 7;
wherein said plurality of light emitting diodes are disposed in such an arrangement as the light emitting diodes are distributed in one portion with a density different from that in other portions.

9. The LED indicator lamp as in one of claims 1 to 8;
wherein said plurality of light emitting diodes include one or more light emitting diodes that are intended to correct unevenness in the light intensity distribution of the luminous intensity distribution pattern produced by the light emitted through the condenser lens.

10. The LED indicator lamp as in one of claims 1 to 9;
wherein said plurality of light emitting diodes are disposed in such an arrangement as the light emitting diodes are placed in at least one portion at intervals different from the intervals between light emitting diodes in other portion.

11. The LED indicator lamp as in one of claims 1 to 10 further comprising a translucent cover placed in front of the condenser lens.

12. The LED indicator lamp according to claim 1;
wherein said translucent cover has a lens pattern formed thereon so as to smooth out the periodic intensity distribution generated by the periodic arrangement of said light emitting diodes.

13. A LED indicator lamp which has a luminous intensity distribution characteristic comprising;
a plurality of light emitting diodes, a condenser lens placed in front of the plurality of light emitting diodes and a translucent cover with a lens pattern formed thereon being placed in front of the condenser lens,
wherein said plurality of light emitting diodes are arranged in a pattern that corresponds to a luminous intensity distribution pattern that is set based on said luminous intensity distribution characteristic,
wherein said light emitting diodes, said condenser lens and said translucent cover are arranged so that the luminous intensity distribution characteristic is achieved by the light that is emitted by said plurality of light emitting diodes through the condenser lens and said translucent cover in the luminous intensity distribution pattern.

14. The LED indicator lamp according to claim 13;
wherein said lens pattern formed on the translucent cover are formed so as to smooth out the periodic intensity distribution generated by the periodic arrangement of said light emitting diodes.
